(19) United States
(12) Patent Application Publication
(10) Pub. No.: US 2002/0020307 A1
(43) Pub. Date: Feb. 21, 2002

(54) Driving device for a press

(76) Inventor: Shozo Imanishi, Sagamihara-shi (JP)

Correspondence Address: MORRISON LAW FIRM, 145 North Fifth Avenue, Mt. Vernon, NY, 10550, US

(21) Appl. No.: 09/910,457

(22) Filed: Jul. 20, 2001

(30) Foreign Application Priority Data
Jul. 27, 2000 (JP) 2000-226857

(51) Int. Cl. B30B 1/06

(52) U.S. Cl. 100/257; 83/615; 100/282; 100/285

(57) ABSTRACT

A slide drive device for a press drives a slide without employing a horizontal slide guide mechanism. Connecting rods move in a linear-type motion level with a balanced crank shaft to minimize vibration. A dynamic balance mechanism further reduces vibration and a slide height adjustment mechanism enables simple top and bottom dead center slide adjustment from a central location. The connecting rods transmit force from the crank shaft to upper links, and through middle and lower links to the slide. A fixed fulcrum pin on the upper link is vertically aligned with a slider pin on the middle link. A center fulcrum pin connects the upper and middle links at a fixed relationship. The slide drive device provides a lower slide speed for increased force adjacent the bottom dead center position and higher slide speed adjacent the top dead center position for speedier return.

### BACKGROUND TO THE PRESENT INVENTION

1. Field of the Invention

The present invention relates to a press that includes a slide drive mechanism, a dynamic balance mechanism, and a die height adjustment mechanism.

2. Description of the Related Art

Japanese Laid Open Patent Publication Number 8-118082 discloses a two point type press that employs a knuckle motion mechanism. The press has a relatively small number of links and has a dynamic balancer drive of a rebound format. The press has very little change in the bottom dead center position resulting from slide speed changes. Japanese Examined Patent Publication Number 53-22305 discloses a type of die height adjusting mechanism.

In Japanese Laid Open Patent Publication Number 8-118082, there are negative results from abrasion and heat generation during operation. In this related art, a slider of a horizontal guide mechanism directly receives a press load. Abrasion of the slider causes the clearance between the horizontal guide groove and the slider to increase. As a result, the parallelism of the slide cannot be maintained resulting in unacceptable failures.

In the related art a die height adjusting mechanism of some type is generally mounted on the slide. However, with high speed automatic presses, the slide has a high frequency motion, and to reduce the slide weight, the die height adjusting mechanism is often attached to the crown. An example of this compromising arrangement is described in Japanese Examined Patent Publication 53-22305. In this related art, the adjustment mechanism is mounted on both the left and the right sides of the press and resultantly, costs are prohibitively excessive.

### OBJECTS AND SUMMARY OF THE INVENTION

It is an object of the present invention to provide a press that may include a slide drive mechanism, a dynamic balance mechanism, and a die height adjustment mechanism.

It is another object of the present invention to provide a press that enjoys reduced operational costs and reduced failure rates.

It is another object of the present invention to provide a press where a slide can be adjusted at a single location at a center of the press.

It is another object of the present invention to provide a press where a center fulcrum pin is at an intermediate point on a middle link.

It is another object of the present invention to provide a press where a slider is equipped with an adjusting mechanism that can adjust the vertical position of the slider.

It is another object of the present invention to provide a press that substantially eliminates the horizontal guide mechanisms of the prior art.

It is another object of the present invention to provide a press where eccentric parts of a crank shaft maintain a left-right phase balance and each side of the press operates in unison.

It is another object of the present invention to provide a press where multiple links, sliders, pins, rods, and plungers are on both sides of a press centerline drawn through the rotation center of the crank shaft.

Briefly stated, the present invention relates to a press machine that includes a slide drive mechanism, a dynamic balance mechanism, and a die height adjustment mechanism. A slide drive device for a press drives a slide without employing a horizontal slide guide mechanism. Connecting rods move in a linear-type motion level with a balanced crank shaft to minimizes vibration. A dynamic balance mechanism further reduces vibration and a slide height adjustment mechanism enables simple top and bottom dead center slide adjustment from a central location. The connecting rods transmit force from the crank shaft to upper links, and through middle and lower links to the slide. A fixed fulcrum pin on the upper link is vertically aligned with a slider pin on the middle link. A center fulcrum pin connects the upper and middle links at a fixed relationship. The slide drive device provides a lower slide speed adjacent the bottom dead center position for increased force and higher speed adjacent the top dead center position for speedier return.

According to one embodiment of the present invention, there is provided a slide drive device for a press machine having a slide, comprising: a slide, said slide includes a top and a bottom dead center position, adjusting means for permitting adjustment of a stroke of said slide, said adjusting means simultaneously adjusting said top and bottom dead center positions by a same amount, and said adjusting means being located at the same location on said press machine.

According to another embodiment of the present invention there is provided a slide drive device, further comprising: driving means for driving of said slide drive device, at least a first upper link, said first upper link being connected to drive said slide in said cycle, said driving means transmitting a driving displacement to said first upper link to drive said slide in said cycle, and said means for driving transmitting said adjustment to said slide whereby said stroke is adjusted.

According to another embodiment of the present invention there is provided a slide drive device, further comprising: dynamically balancing means for permitting dynamic balancing of said slide drive device, a dynamic balancer operably connected to said slide, said dynamically balancing means connected to said dynamic balancer, said dynamically balancing means being operably connected to move said dynamic balancer opposite said slide in said cycle, said means for driving connected to transmit said driving displacement to said dynamically balancing means, and said dynamically balancing means moving said dynamic balancer opposite said slide in said cycle whereby said dynamic balancer operates to dampen vibration from said slide.

According to another embodiment of the present invention there is provided a slide drive device, further comprising: guiding means for guiding of said slide drive device, at least a first horizontal link, said first horizontal link operably connecting to said slide, said guiding means guiding said first horizontal link in said cycle, said driving means including said guiding means, and said guiding means guiding said adjustment and said driving displacement to said slide whereby said stroke is adjusted.

According to another embodiment of the present invention there is provided a slide drive device, further comprising: a crank shaft, at least a first connecting rod on said crank shaft, said connecting rod receiving a reciprocating motion and transmitting said reciprocating motion to said means for driving, said connecting rod and said means for driving being effective to transmit said reciprocating motion to said dynamically balancing means, and said guiding means being effective to convert said reciprocating motion to a guiding displacement, whereby said slide operates in said cycle.

According to another embodiment of the present invention there is provided a slide drive device, further comprising: said at least first upper link having a first length (a), at least a first middle link, a center fulcrum pin on said first middle link, said first upper link operably connecting to said first middle link at said center fulcrum pin, a first and second end on said first middle link, said fist connecting rod operably coupled to said second end, said first middle link having a second length (b) from said first end to said center fulcrum pin, said first middle link having a third length (c) from said second end to said center fulcrum pin, and said first, second, and third lengths having the following relationship:

(a):(b)=(b):(c) (I)

whereby said first connecting rod transmits said driving displacement to said fist upper link and said first middle link and driving means reduces a slide speed adjacent said bottom dead center position and increases said slide speed distal said bottom dead center position.

According to another embodiment of the present invention there is provided a slide drive device, comprising: a slide, said slide having a top and a bottom dead center position, adjusting means for adjusting a stroke of said slide, said adjusting means simultaneously adjusting said top and bottom dead center positions by a same amount, said adjusting means being located at the same location on said press machine; driving means for permitting driving of said slide drive device, at least a first upper link, said first upper link being connected to drive said slide in said cycle, said driving means transmitting a driving displacement to said slide to drive said slide in said cycle, and said means for driving transmitting said adjustment to said slide whereby said stroke is adjusted.

According to another embodiment of the present invention there is provided a slide drive device, further comprising: guiding means for guiding of said slide drive device, at least a first horizontal link, a second linear guide, a second slider operably slidable in said second linear guide, said one horizontal link operably joined to said second slider, said second slider receiving said driving displacement from said driving means, said guiding means being effective to guide said adjustment to said slide, and said first horizontal link driving said slide in said cycle whereby said stroke is adjusted and said top and bottom dead center positions are adjusted by the same amount.

According to another embodiment of the present invention there is provided a slide drive device, further comprising: dynamically balancing means permitting dynamic balancing of said slide drive device, said dynamically balancing means connecting a dynamic balancer to said slide, said dynamically balancing means connects to operate said dynamic balancer opposite said slide, said dynamically balancing means receiving said guiding displacement, and said dynamically balancing means being effective to operate said dynamic balancer opposite said slide whereby said dynamically balancing means and said dynamic balancer counter a momentive force of said slide in said cycle and substantially lower vibration in said slide drive device.

According to another embodiment of the present invention there is provided a slide drive device, further comprising: a crank shaft, a center of said crank shaft vertically aligned with said second slider, at least one of a first and second eccentric part on said crank shaft, said first and second eccentric parts diametrically opposed on said crank shaft, said first and second eccentric parts balanced about a rotation center of said crank shaft, at least one connecting rod on said one eccentric part, said connecting rod receiving a reciprocating motion and transmitting said reciprocating motion to said driving means, said driving means being effective to transmit said reciprocating motion to said dynamically balancing means, and guiding means being effective to convert said reciprocating motion to a guiding displacement, whereby said slide operates in said cycle.

According to another embodiment of the present invention there is provided a slide drive device, further comprising: a small and a large end on said one connecting rod, said large end operably attached to said one eccentric part, said small end operably attached to said driving means, and said small end reciprocating linearly to a rotation center of said crank shaft whereby said driving displacement is transmitted to said slide.

According to another embodiment of the present invention there is provided a slide drive device, further comprising: at least a first upper link, said first upper link operable about a fixed fulcrum pin, said at least one upper link having a first length (a), at least a first middle link, a center fulcrum pin on said first middle link, said first upper link pivotably joined to said one middle link at said center fulcrum pin, a first and second end on said one middle link, said one connecting rod operably coupled to said second end, said one middle link having a second length (b) from said first end to said center fulcrum pin, said one middle link having a third length (c) from said second end to said center fulcrum pin, and said first, second, and third lengths having the following relationship:

(a):(b)=(b):(c) (II)

whereby said one connecting rod transmits said driving displacement to said first upper link and said first middle link and said driving means drives said slide in said cycle and reduces a slide speed adjacent said bottom dead center position and increases said slide speed distal said bottom dead center position.

According to another embodiment of the present invention there is provided a slide drive device, further comprising: a guide pin, said guide pin guiding said dynamic balancer opposite said slide, a balancer pin, said balancer pin operably joined to said dynamic balancer, a balancer link, said balancer link operably joining said balancer pin to said one connecting rod, said balancer link receiving said driving displacement and transmitting said guiding displacement to said dynamic balancer whereby said dynamic balancer operates opposite said slide and substantially eliminates vibration, and said dynamic balancing means having a shape adapted to said driving means whereby said slide drive device is compact in size.

According to another embodiment of the present invention there is provided a slide drive device, further comprising: said balancer pin is vertically aligned with said fixed fulcrum pin.

According to another embodiment of the present invention there is provided a slide drive device, further comprising: a first linear guide, said first linear guide vertically aligned with said fixed fulcrum pin and said balancer pin, a first slider operably slidable in said first linear guide, said first end of said one middle link operably joined to said first slider, said one middle link operably transmitting said driving displacement from said one connecting link to said first slider, at least one of a first and second lower link, a first and second side on said one horizontal link, said first side operably joined to said second slider, said second side operably joined to said one lower link, said one lower link operably joining said first slider and said one horizontal link, and said first slider being effective to convert said driving displacement to a linear displacement whereby said one lower link operably drives said one horizontal link and said slide in said cycle.

According to another embodiment of the present invention there is provided a slide drive device, comprising: a crank shaft, at least a first eccentric part on said crank shaft, a second eccentric part on said crank shaft, said first and second eccentric parts operably opposing each other about a rotation center of said crank shaft, at least one of a first and second connecting rod, said one connecting rod operably joined to said one eccentric part, said one connecting rod receiving a driving displacement from said crank shafts, at least one of a first and second upper link, said one upper link operable about a fixed fulcrum pin, at least one of a first and second middle link, said one middle link having a first and second end, said one connecting rod effective to transfer said driving displacement to said one middle link at said second end, said one upper link operably joined to said one middle link at a center fulcrum point between said first and second ends; said one middle link effective to transfer said driving displacement to said one upper link, said one middle link and said one upper link operably effective to transfer said driving displacement to a slide and drive said slide in a cycle, said one connecting rod having a having a length (a), said center fulcrum point a length (c) from said second end, said center fulcrum pont a length (b) from said first end, and said lengths (a), (b), (c), having the following relationship:

(a):(b)=(b):(c) (III)

whereby said one connecting link operates horizontally to said crank shaft and said one upper link and said one middle link are effective to transfer said driving displacement to said slide and drive said slide in said cycle at a low speed adjacent said bottom dead center for increased force and a fast speed distal said bottom dead center for a speedier return.

According to another embodiment of the present invention there is provided a slide drive device, further comprising: means for adjusting said slide drive device, a top and a bottom dead center position of said slide, said adjusting means permitting adjustment of a stroke of said slide, said adjusting means permitting adjustment of said top and bottom dead center position at the same time, said adjusting means permitting said adjustment of said top and bottom dead center positions by the same amount, at least one of a first and second horizontal link, a first and second end on said one horizontal link, said one horizontal link effective to receive said driving displacement at said second end, said one horizontal link effective to receive said adjustment at said first end, and said one horizontal link effective to transfer said driving displacement and said adjustment to said slide whereby said slide is adjusted and driven in said cycle.

According to another embodiment of the present invention there is provided a slide drive device, further comprising: means for dynamically balancing said slide drive device, said dynamic balancing means operably moving a dynamic balancer opposite said slide in said cycle, a guide pin operably guiding said dynamic balancer during said cycle, said guide pin vertically aligned with said fixed fulcrum pin, said dynamic balancing means driven by said one connecting rod, and said dynamic balancing means being effective to counter a momentive force of said slide and said one connecting rod whereby said slide operates in said cycle with substantially lower vibration.

The above, and other objects, features, and advantages of the present invention will become apparent from the following description read in conjunction with the accompanying drawings, in which like reference numerals designate the same elements.

### BRIEF DESCRIPTION OF THE FIGURES

FIG. 1 is a descriptive drawing disclosing the principal parts of a press.

FIG. 2 is a partial cross-section of the principal parts of a slide drive mechanism of the present invention.

FIG. 3 is a skeleton drawing of a slide drive mechanism.

FIG. 4 is a figure showing the motion of a slide of the present invention.

FIG. 5 is a cross-section expanded at the pin sites to show the crank shaft area.

FIG. 6 is a cross-section expanded at the pin sites in show the connections of each link of the present invention.

### DESCRIPTION OF THE PREFERRED EMBODIMENTS

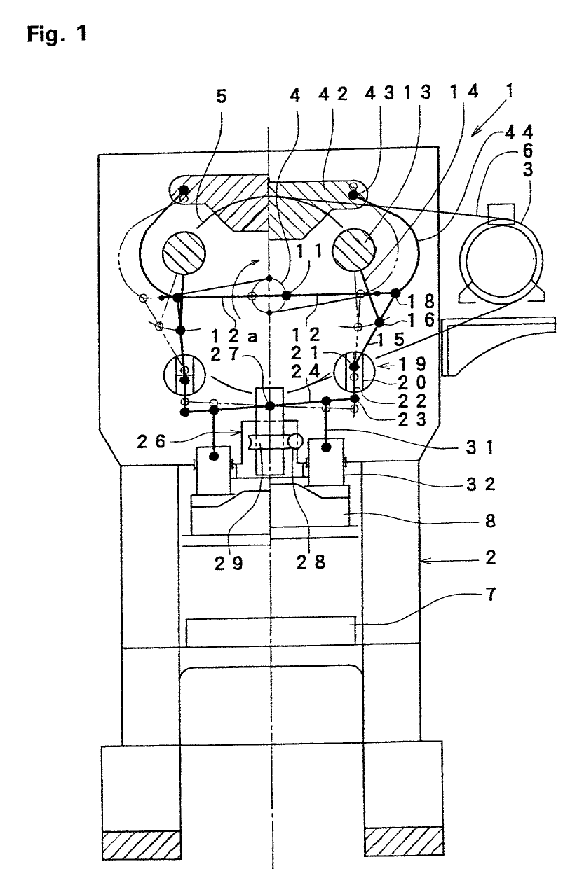

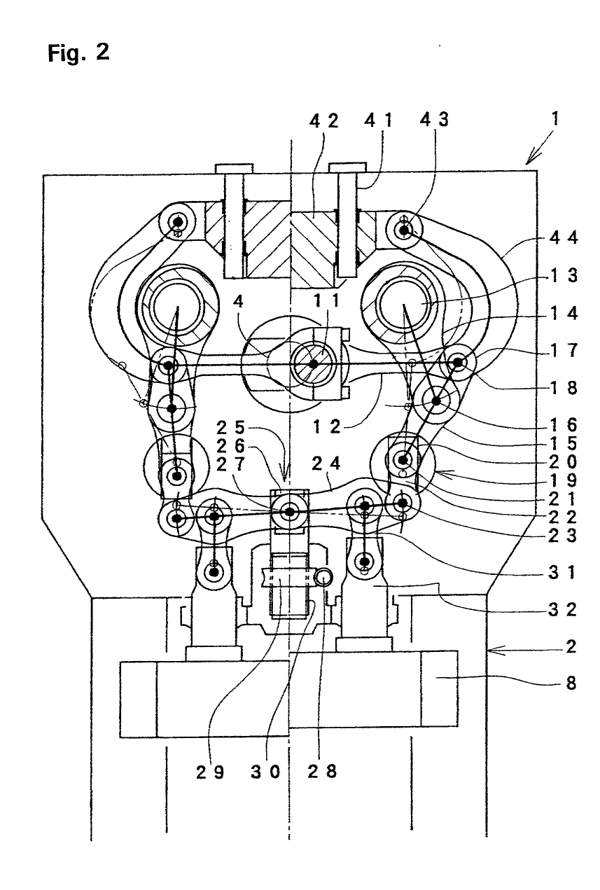

Referring to FIGS. 1 and 2, a main motor 3 is on a frame 2 of a press 1. During operation, a belt 6 transfers power from main motor 3 to a fly wheel 5. A crank shaft 4 extends from frame 2 to fly wheel 5. Fly wheel 5 transmits power from belt 6 to crank shaft 4.

A bolster 7 is affixed to a bottom portion of frame 2. A slide 8 operates along frame 2 above bolster 7. Slide 8 operates in an up-down manner. An upper and lower mold (both not shown) are attached respectively to slide 8 and bolster 7. The upper and lower molds (now shown) operate to press work objects (not shown).

Crank shaft 4 is supported by frame 2. Crank shaft 4 is in a front-back direction of press 1 but may be positioned differently as long as weight is balanced in press 1. Crank shaft 4 includes eccentric parts 11 and eccentric part 11a (shown later).

Eccentric parts 11 and eccentric part 11a have the same eccentricity relative to a center of crank shaft 4. Eccentric parts 11 and eccentric part 11a are directly opposite each other with a phase shift of 180 degrees.

Connecting rods 12 and connecting rod 12a connect each respective eccentric parts 11 and eccentric part 11a to first pins 18, as will be explained. Connecting rods 12 and connecting rod 12a each have a large end part and a small end part. The large end parts of connecting rods 12 and connecting rod 12 connect to each respective eccentric parts 11 and eccentric part 11a.

Connecting rods 12 and connecting rod 12a have the same shape opposite a centerline of crank shaft 4. To maintain the weight equilibrium of press 1 and frame 2, in a front-back direction, a thickness of each connecting rod 12 is one half the thickness of connecting rod 12a. To further maintain weight equilibrium, connecting rods 12 are both opposite connecting rod 12a on crank shaft 4 and respective eccentric parts 11a and eccentric part 11. It is to be understood that connecting rods 12, connecting rod 12a, eccentric parts 11a and eccentric part 11 do not need to be a particular shape or size as long as each functions and weight equilibrium is maintained.

A pin (not shown) operably attaches each eccentric part 11 and eccentric parts 11a to each respective connecting rod 12 or connecting rods 12a. The pins have a thickness corresponding to a thickness of each respective eccentric part 11 and eccentric parts 11a. i.e. long or short pins.

It is to be understood that press 1 includes at least one slide drive mechanism, dynamic balance mechanism, and die height adjustment mechanism.

A centerline is shown through press 1 and a center of crank shaft 4. The present preferred embodiment is symmetrical about the centerline, but symmetry is not required for operation. It is to be understood, that the below discussion describes one half of a slide drive mechanism, dynamic balance mechanism, and die height adjustment mechanism.

The left hand side of FIGS. 1 and 2 is at a bottom dead center position of slide 8. The right hand side of FIGS. 1 and 2 is a top dead center position of slide 8.

A fixed fulcrum pin 13 is affixed to frame 2. Fixed fulcrum pin 13 is at a position above crank shaft 4. One end of an upper link 14 connects to fixed fulcrum pin 13 in an oscillating manner. A second end of upper link 14 connects to a middle link 15 at a center fulcrum pin 16. Upper links 14 rotatably connect fixed fulcrum pins 13 to center fulcrum pins 16.

Connecting rods 12 and connecting rod 12a each have a small end part 17 First pin 18 connects a first end of each middle link 15 with each respective small endparts 17.

A slider pin 21 connects a second end of each middle link 15 to a first end of a first slider 20. A first linear guide 19 slidably and vertically retains first slider 20. First linear guide 19 is affixed to frame 2 directly below fixed fulcrum pin 13.

One end of a lower link 22 connects to slider pin 21 of first slider 20. A second pin 23 connects a second end of lower link 22 to a first end of a horizontal link 24.

A central pin 27 connects a second end of horizontal link 24 to a second slider 26. A second linear guide 25 slidably and vertically retains second slider 26. Second linear guide 25 is directly below the centerline of crank shaft 4.

A screw 30 is directly below second linear guide 25. A worm 28 and a worm wheel engage screw 30 for adjustment. During adjustment, by a transfer means (not shown), worm 28 rotates and engages worm wheel 29. Screw 30 screws into worm wheel 29 and is adjustable through worm wheel 29. As screw 30 moves upward or downward, second slider 26 also moves upward or downwards to adjust the position of central pin 27.

A first end of a connecting link 31 rotatably connects to an intermediate point on horizontal link 24. The intermediate point is at a position between second pin 23 and central pin 27. A second end of connecting link 31 connects to a plunger 32. Connecting link 31 connects the intermediate point and plunger 32. Plunger 32 is upright on slide 8.

During adjustment, when worm 28 is rotated by the transfer means (not shown), central pin 27 of second slider 26 moves upward and downward. This adjustment adjusts each horizontal link 24, each connecting link 31, and each plunger 32. It is to be therefore understood, that during adjustment, when worm 28 rotates, slide 8 is adjusted and results in a uniform die height adjustment from a single point.

The following describes a dynamic balance mechanism according to the present embodiment. In an upper part of frame 2, a guide pin 41 is suspended on frame 2. A dynamic balancer 42 is on guide pin 41 and can be moved up and down relative to frame 2. A balancer pin 43 is on dynamic balancer 42. Balancer pin 43 is directly above fixed fulcrum pin 13.

A balancer link 44 connects balancer pin 43 and first pin 18, of small end part 17 of connecting rod 12. It is to be understood that the outer shape of press 1 may be made compact by shaping balancer link 44 to curve around a perimeter of fixed fulcrum pin 13. It is to be further understood that the curved shape of balancer link 44, of the preferred embodiment, is not restricted to the shape shown, but may be any shape providing the required connecting ability.

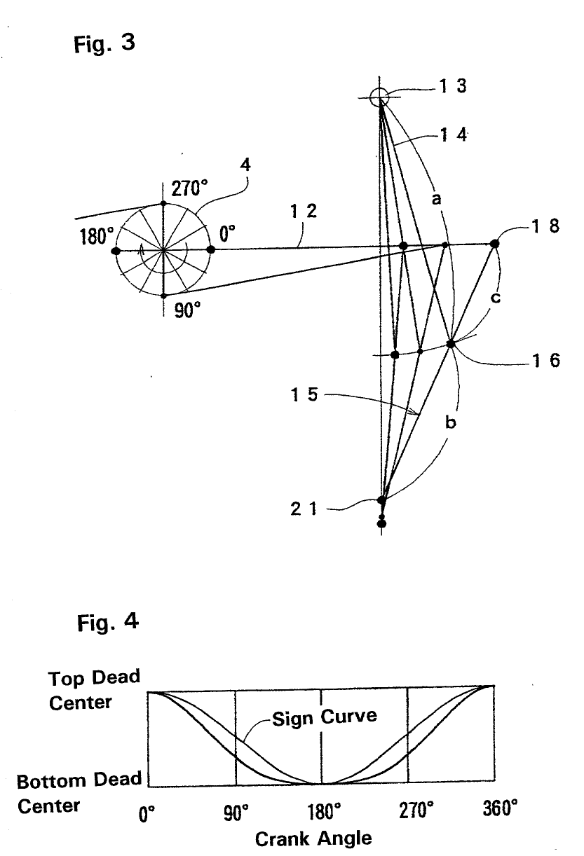

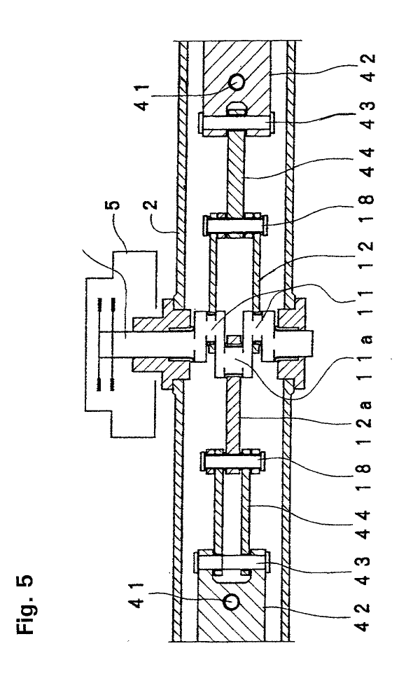

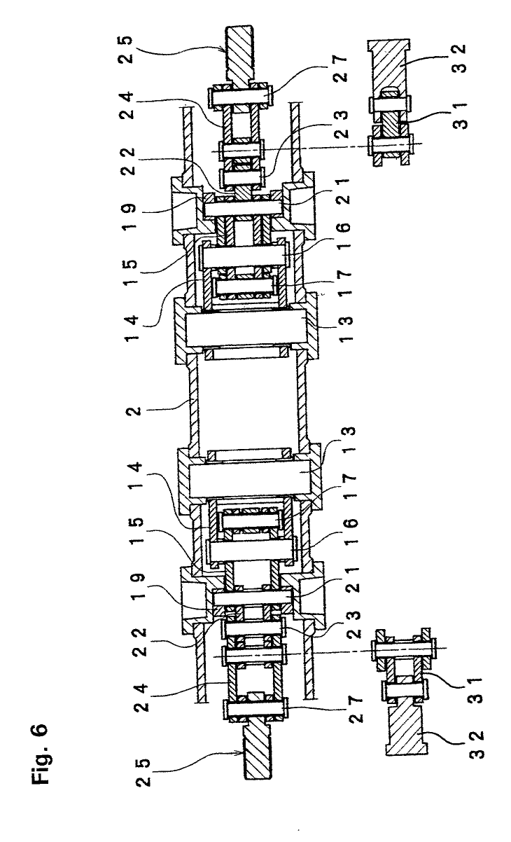

Referring additionally now to FIG. 3, a distance ‘a’ is defined between fixed fulcrum pin 13 of upper link 14 and center fulcrum pin 16. A distance ‘b’ is defined between center fulcrum pin 16 and slider pin 21. A distance ‘c’ is defined between center fulcrum pin 16 and first pin 18 of small end part 17. It is to be understood that center fulcrum pin 16 is provided at a position on middle link 15 where distances ‘a’, ‘b’, and ‘c’ are approximately represented by the relationship:

a:b=b:c (IV)

It is to be further understood that the position of small end part 17 is along a horizontal line of crank shaft 4. It is to be further understood that the following positions are all established under the above relationship: the positions of fixed fulcrum pin 13 and first linear guide 19, the interval between fixed fulcrum pin 13 of upper link 14 and center fulcrum pin 16, the interval between first pin 18 and center fulcrum pin 16, and the interval between slider pin 21 and center fulcrum pin 16.

It is to be further understood that when crank shaft 4 rotates and connecting rods 12 and connecting rod 12 oscillates, first pins 18 have an approximately linear motion along a horizontal line from the center of crank shaft 4.

It is to be further understood, that when fixed fulcrum pin 13 is on the same side as slider pin 21, with respect to a movement direction of first pin 18, the above requirements for the position of center fulcrum pin 16 is shown as an approximately linear motion mechanism of a Scott-Russell-type.

In the present invention, this approximately linear motion mechanism is expanded so that when fixed fulcrum pin 13 is on an opposite side of slider pin 21 with respect to the movement direction of first pin 18, the approximately linear motion mechanism can be established within the limited oscillation angle of upper link 14.

Referring additionally now to FIG. 4, indicating the motion of first slide 20 during one rotation of crank shaft 4. Compared to a sine curve, the speed change near the bottom dead center is more gradual. It is to be understood, that due to the above mechanisms, the approach rate of slide 8 is lowered immediately before and after the bottom dead center position. Since the remainder of the stroke cycle must still occur during one rotation of crank shaft 4 the remainder of the slide cycle is made faster and quicker. As a result, the pressing operation is made more efficient and quality is improved.

In the above described embodiment of the press of the present invention, its slide drive mechanism, dynamic balance mechanism, and die height adjusting mechanism can be implemented alternative manners depending upon manufacturer need.

In other words, with the slide drive mechanism shown in the preferred embodiment, the dynamic balance mechanism and die height adjustment mechanism may be omitted or replaced with other embodiments. For example, by making slider pin 21 and second pin 23 the same, first linear guide 19 and horizontal link 24 become unnecessary. This adaptation is undesirably since the die height adjusting mechanism must then be mounted on the slider side.

Furthermore, with the dynamic balance mechanism shown in the embodiment, the present invention is not restricted to inputting power into first pin 18 by connecting rods 12, 12a from eccentric parts 11, 11a that have 180 degree symmetry. Methods of inputting into drive points of either the small end part 17 of the connecting rod 12 or the toggle link can be implemented.

Furthermore, two point or four point presses can implement the die height adjustment mechanism shown in the present embodiment, with similar kinds of slide drive mechanisms.

It is to be understood, that small end part 17 of connecting rod 12, has an approximately linear motion along a horizontal line from crank shaft 4. As a result, the horizontal guide mechanisms of the prior art may be omitted as unnecessary. It is to be further understood, that due to the 180 degree symmetry of the present invention, a left-right balance of press 1 is maintained during operation thereby limiting vibration, equipment ware and failure.

It is to be further understood, that because dynamic balance is maintained during rotation of crank shaft 4, the vibration of press 1 and slide 8 is suppressed.

It is to be further understood, that adjustments to die height correspondingly adjust the stroke of slide 8, so that mechanisms for adjusting die height correspondingly adjust the stroke of slide 8.

It is to be further understood, that by adjusting a position of second slider 26, the die height of slide 8 can be adjusted. This die height adjusting mechanism is mounted at a single location at the center of press 1 thereby eliminating the need for synchronized driving and reducing cost, space, and complexity. It is to be understood, that adjustments to die height adjust the stroke of slide 8.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the scope of this invention as defined in the following claims. In the claims, means-plus-function clauses are intended to cover the structures described or suggested herein as performing the recited function and not only structural equivalents but also equivalent structures. Thus although a nail and screw may not be structural equivalents in that a nail relies entirely on friction between a wooden part and a cylindrical surface whereas a screw's helical surface positively engages the wooden part, in the environment of fastening wooden parts, a nail and a screw may be equivalent structures.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A slide drive device for a press machine, comprising:
a slide;
said slide includes a top and a bottom dead center position;
adjusting means for permitting adjustment of a stroke of said slide;
said adjusting means simultaneously adjusting said top and bottom dead center positions by a same amount; and
said adjusting means being located at the same location on said press machine.

2. A slide drive device, according to claim 1, further comprising:
driving means for driving of said slide drive device;
at least a first upper link;
said first upper link being connected to drive said slide in said cycle;
said driving means transmitting a driving displacement to said first upper link to drive said slide in said cycle; and
said means for driving transmitting said adjustment to said slide whereby said stroke is adjusted.

3. A slide drive device, according to claim 2, further comprising:
dynamically balancing means for permitting dynamic balancing of said slide drive device;
a dynamic balancer operably connected to said slide;
said dynamically balancing means connected to said dynamic balancer;
said dynamically balancing means being operably connected to move said dynamic balancer opposite said slide in said cycle;
said means for driving connected to transmit said driving displacement to said dynamically balancing means; and
said dynamically balancing means moving said dynamic balancer opposite said slide in said cycle whereby said dynamic balancer operates to dampen vibration from said slide.

4. A slide drive device, according to claim 3, further comprising:
guiding means for guiding of said slide drive device;
at least a first horizontal link;
said first horizontal link operably connecting to said slide;
said guiding means guiding said first horizontal link in said cycle;
said driving means including said guiding means; and
said guiding means guiding said adjustment and said driving displacement to said slide whereby said stroke is adjusted.

5. A slide drive device, according to claim 4, further comprising:
a crank shaft;
at least a first connecting rod on said crank shaft;
said connecting rod receiving a reciprocating motion and transmitting said reciprocating motion to said means for driving;
said connecting rod and said means for driving being effective to transmit said reciprocating motion to said dynamically balancing means; and
said guiding means being effective to convert said reciprocating motion to a guiding displacement, whereby said slide operates in said cycle.

6. A slide drive device, according to claim 5, further comprising:
said at least first upper link having a first length (a);
at least a first middle link;
a center fulcrum pin on said first middle link;
said first upper link operably connecting to said first middle link at said center fulcrum pin;
a first and second end on said first middle link;
said fist connecting rod operably coupled to said second end;
said first middle link having a second length (b) from said first end to said center fulcrum pin;
said first middle link having a third length (c) from said second end to said center fulcrum pin; and
said first, second, and third lengths having the following relationship:
(a):(b)=(b):(c) (V)
whereby said first connecting rod transmits said driving displacement to said fist upper link and said first middle link and driving means reduces a slide speed adjacent said bottom dead center position and increases said slide speed distal said bottom dead center position.

7. A slide drive device for a press machine having a slide, comprising:
a slide;
said slide having a top and a bottom dead center position;
adjusting means for adjusting a stroke of said slide;
said adjusting means simultaneously adjusting said top and bottom dead center positions by a same amount;
said adjusting means being located at the same location on said press machine;
driving means for permitting driving of said slide drive device;
at least a first upper link;
said first upper link being connected to drive said slide in said cycle;
said driving means transmitting a driving displacement to said slide to drive said slide in said cycle; and
said means for driving transmitting said adjustment to said slide whereby said stroke is adjusted.

8. A slide drive device, according to claim 7, further comprising:
guiding means for guiding of said slide drive device:
at least a first horizontal link;
a second linear guide;
a second slider operably slidable in said second linear guide;
said one horizontal link operably joined to said second slider;
said second slider receiving said driving displacement from said driving means;
said guiding means being effective to guide said adjustment to said slide; and
said first horizontal link driving said slide in said cycle whereby said stroke is adjusted and said top and bottom dead center positions are adjusted by the same amount.

9. A slide drive device, according to claim 8, further comprising:
dynamically balancing means permitting dynamic balancing of said slide drive device;
said dynamically balancing means connecting a dynamic balancer to said slide;
said dynamically balancing means connects to operate said dynamic balancer opposite said slide;
said dynamically balancing means receiving said guiding displacement; and
said dynamically balancing means being effective to operate said dynamic balancer opposite said slide whereby said dynamically balancing means and said dynamic balancer counter a momentive force of said slide in said cycle and substantially lower vibration in said slide drive device.

10. A slide drive device, according to claim 9, further comprising:
a crank shaft;
a center of said crank shaft vertically aligned with said second slider;
at least one of a first and second eccentric part on said crank shaft;
said first and second eccentric parts diametrically opposed on said crank shaft;
said first and second eccentric parts balanced about a rotation center of said crank shaft;
at least one connecting rod on said one eccentric part;
said connecting rod receiving a reciprocating motion and transmitting said reciprocating motion to said driving means;
said driving means being effective to transmit said reciprocating motion to said dynamically balancing means; and
guiding means being effective to convert said reciprocating motion to a guiding displacement, whereby said slide operates in said cycle.

11. A slide drive device, according to claim 10, further comprising:
a small and a large end on said one connecting rod;
said large end operably attached to said one eccentric part;
said small end operably attached to said driving means; and
said small end reciprocating linearly to a rotation center of said crank shaft whereby said driving displacement is transmitted to said slide.

12. A slide drive device, according to claim 11, further comprising:
at least a first upper link;
said first upper link operable about a fixed fulcrum pin;
said at least one upper link having a first length (a);
at least a first middle link;
a center fulcrum pin on said first middle link;
said first upper link pivotably joined to said one middle link at said center fulcrum pin;
a first and second end on said one middle link;
said one connecting rod operably coupled to said second end;
said one middle link having a second length (b) from said first end to said center fulcrum pin;
said one middle link having a third length (c) from said second end to said center fulcrum pin; and
said first, second, and third lengths having the following relationship:
(a):(b)=(b):(c) (VI)
whereby said one connecting rod transmits said driving displacement to said first upper link and said first middle link and said driving means drives said slide in said cycle and reduces a slide speed adjacent said bottom dead center position and increases said slide speed distal said bottom dead center position.

13. A slide drive device, according to claim 12, further comprising:
a guide pin;
said guide pin guiding said dynamic balancer opposite said slide;
a balancer pin;
said balancer pin operably joined to said dynamic balancer;
a balancer link;
said balancer link operably joining said balancer pin to said one connecting rod;
said balancer link receiving said driving displacement and transmitting said guiding displacement to said dynamic balancer whereby said dynamic balancer operates opposite said slide and substantially eliminates vibration; and
said dynamic balancing means having a shape adapted to said driving means whereby said slide drive device is compact in size.

14. A slide drive device, according to claim 13, wherein:
said balancer pin is vertically aligned with said fixed fulcrum pin.

15. A slide drive device, according to claim 14, further comprising:
a first linear guide;
said first linear guide vertically aligned with said fixed fulcrum pin and said balancer pin;
a first slider operably slidable in said first linear guide;
said first end of said one middle link operably joined to said first slider;
said one middle link operably transmitting said driving displacement from said one connecting link to said first slider;
at least one of a first and second lower link;
a first and second side on said one horizontal link;
said first side operably joined to said second slider;
said second side operably joined to said one lower link;
said one lower link operably joining said first slider and said one horizontal link; and
said first slider being effective to convert said driving displacement to a linear displacement whereby said one lower link operably drives said one horizontal link and said slide in said cycle.

16. A slide drive device, for a press machine having a slide, comprising:
a crank shaft;
at least a first eccentric part on said crank shaft;
a second eccentric part on said crank shaft
said first and second eccentric parts operably opposing each other about a rotation center of said crank shaft;
at least one of a first and second connecting rod;
said one connecting rod operably joined to said one eccentric part;
said one connecting rod receiving a driving displacement from said crank shafts;
at least one of a first and second upper link;
said one upper link operable about a fixed fulcrum pin;
at least one of a first and second middle link;
said one middle link having a first and second end;
said one connecting rod effective to transfer said driving displacement to said one middle link at said second end;
said one upper link operably joined to said one middle link at a center fulcrum point between said first and second ends.
said one middle link effective to transfer said driving displacement to said one upper link;
said one middle link and said one upper link operably effective to transfer said driving displacement to a slide and drive said slide in a cycle;
said one connecting rod having a having a length (a)
said center fulcrum point a length (c) from said second end;
said center fulcrum pont a length (b) from said first end; and
said lengths (a), (b), (c), having the following relationship:
(a):(b)=(b):(c) (VII)
whereby said one connecting link operates horizontally to said crank shaft and said one upper link and said one middle link are effective to transfer said driving displacement to said slide and drive said slide in said cycle at a low speed adjacent said bottom dead center for increased force and a fast speed distal said bottom dead center for a speedier return.

17. A slide drive device, according to claim 16, further comprising:
means for adjusting said slide drive device;
a top and a bottom dead center position of said slide;
said adjusting means permitting adjustment of a stroke of said slide;
said adjusting means permitting adjustment of said top and bottom dead center position at the same time;
said adjusting means permitting said adjustment of said top and bottom dead center positions by the same amount;
at least one of a first and second horizontal link;
a first and second end on said one horizontal link;
said one horizontal link effective to receive said driving displacement at said second end;
said one horizontal link effective to receive said adjustment at said first end; and
said one horizontal link effective to transfer said driving displacement and said adjustment to said slide whereby said slide is adjusted and driven in said cycle.

18. A slide drive device, according to claim 17, further comprising:
means for dynamically balancing said slide drive device;
said dynamic balancing means operably moving a dynamic balancer opposite said slide in said cycle;
a guide pin operably guiding said dynamic balancer during said cycle;
said guide pin vertically aligned with said fixed fulcrum pin;
said dynamic balancing means driven by said one connecting rod; and
said dynamic balancing means being effective to counter a momentive force of said slide and said one connecting rod whereby said slide operates in said cycle with substantially lower vibration.
